(19) United States
(12) Patent Application Publication
(10) Pub. No.: US 2010/0231009 A1
(43) Pub. Date: Sep. 16, 2010

(54) Foldable massaging backrest structure

(76) Inventor: Shu Chin Chi, Taipei City (TW)

Correspondence Address: Muncy, Geissler, Olds & Lowe, PLLC, 4000 Legato Road, Suite 310, FAIRFAX, VA, 22033, US

(21) Appl. No.: 11/902,081

(22) Filed: Sep. 18, 2007

(51) Int. Cl. A47B 83/02; A47C 7/18; A47C 7/72; A47C 4/54; A61H 99/00

(52) U.S. Cl. 297/155; 297/135; 297/148

(57) ABSTRACT

A foldable massaging backrest structure comprises a main body and a table. The main body includes a cushion and two arms pivotally connected to two lateral sides of the cushion respectively. The cushion has a headrest portion and a backrest portion and is provided with at least a speaker and a battery cell. A massaging device is disposed within the backrest portion adjacent to users' backs. The table is movably connected to the main body for users to place books they are reading or other things thereon.

### BACKGROUND OF THE INVENTION

1. Field of the Invention

The present invention relates to a backrest structure and, more particularly, to a portable foldable massaging backrest structure that includes a table.

2. Description of the Prior Art

After work, People usually feel exhausted because of the long hour in the office and intense concentration into the working load in this highly competitive era. People try to find the best way to relieve daily tiredness when they are back home. Generally, people usually relieve their daily tiredness after work preferably by watching television in bed or in couch and use pillows for backrest. However, if users lean against pillows for a long period of time, they will get sore back-waist or backache easily because pillows are too soft and don't meet the ergonomics. Alternatively, cushions may be used to replace pillows for backrest, but the usage of cushions is limited because there is nowhere for users to place their hands.

Moreover, because of the excellent effects of massages on relieving pressure, people may place and use electric massage chairs in their bedrooms for massaging themselves and watching television simultaneously. However, the electric massage chairs are large, structurally complicated, and have high manufacturing cost, so that the unoccupied room space will be greatly reduced when an electric massage chair is placed therein and it is also not economic for users to purchase.

Furthermore, people may also need to relieve their tiredness when they travel or participate certain outdoor activities. For example, when people stay in a hotel during their travel, they may want to watch television and have massages at the same time. Or, when people go on a picnic or go camping, they have to sit on the grass or camping ground where there is nowhere for them to lean their backs against and are unable to have any massage to relieve their tiredness.

In order to solve the problems mentioned above to provide a portable foldable massaging backrest structure of low manufacturing cost, inventor had the motive to study and develop the present invention after hard research.

### SUMMARY OF THE INVENTION

An object of the present invention is to provide a foldable massaging backrest structure that is structurally simple, small, lightweight, and portable.

Another object of the present invention is to provide a foldable massaging backrest structure having a table for users to put their carry-on things or books they are reading thereon.

Another object of the present invention is to provide a foldable massaging backrest structure having a massaging device for massaging the backs of the users.

Another object of the present invention is to provide a foldable massaging backrest structure having a speaker for outputting recordings, such as preferable music or speech of the users, or broadcasts while the users enjoy massages.

Another object of the present invention is to provide a foldable massaging backrest structure having a battery cell for users to use batteries as power source in places like camping site without power supply.

In order to achieve the above objects, the present invention provides a foldable massaging backrest structure comprising a main body and a table. The main body includes a cushion and two arms pivotally connected to two lateral sides of the cushion respectively. The cushion has a headrest portion and a backrest portion and is provided with at least a speaker and a battery cell. A massaging device is disposed within the backrest portion adjacent to the back of a user. The table is movably connected to the main body for users to place books they are reading or other objects.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 is a perspective view of a first embodiment of the present invention.

FIG. 2 is another perspective view of the first embodiment of the present invention, wherein a table is stored within a recessed space of one arm.

FIG. 3 is still another perspective view of the first embodiment of the present invention.

FIG. 4 is a using state diagram of the first embodiment of the present invention.

FIG. 5 is a schematic view of the first embodiment of the present invention wherein the foldable massaging backrest structure is stored.

FIG. 6 is a perspective view of a second embodiment of the present invention.

FIG. 7 is a sectional view of the second embodiment of the present invention.

FIG. 8 is a perspective view of a third embodiment of the present invention.

FIG. 9 is a perspective view of a fourth embodiment of the present invention.

FIG. 10 is a perspective view of a fifth embodiment of the present invention.

### DETAILED DESCRIPTION OF THE PREFERRED EMBODIMENTS

The present invention provides a foldable massaging backrest structure comprising a main body 1 and a table 2. The main body 1 includes a cushion 10 and two arms 12 pivotally connected with two lateral sides of the cushion 10. The cushion 10 has a headrest portion 101 and a backrest portion 102 and is provided with at least a speaker 104 and a battery cell 105. A massaging device 103 is disposed within the backrest portion near an internal side 106 adjacent to the back of a user for massaging the back of the user.

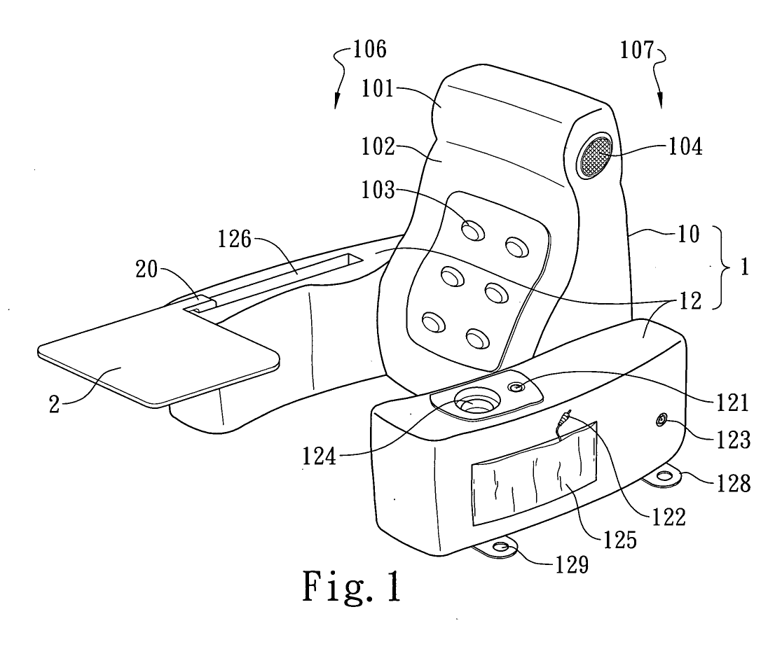

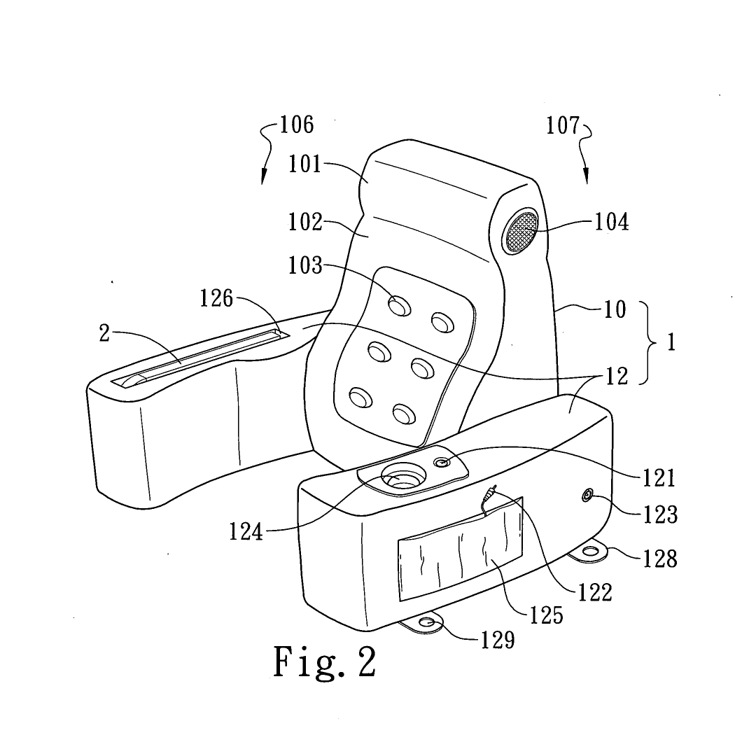

FIGS. 1 and 2 show perspective views of a first embodiment of the present invention. As shown in FIGS. 1 and 2, the foldable massaging backrest structure according to the present invention comprises a main body 1 and a table 2. The main body 1 includes a cushion 10 and two arms 12 pivotally connected with two lateral sides of the cushion 10. The cushion 10 has a headrest portion 101 and a backrest portion 102. A massaging device 103 is disposed within the backrest portion 102 near the internal side 106 adjacent to the back of a user for massaging the back of the user. Besides, the two sides of the headrest portions 101 are provided with a speaker 104 respectively for outputting audio signals.

A power switch 121 and a recessed seat 124 are provided on the top surface of one arm 12. The power switch 121 is used for turning on or off the massaging device 103. The recessed seat 124 is used for users to place their things thereon and can be designed in various shapes. In this embodiment, the recessed seat 124 is in round shape for users to place a round ashtray, a drink bottle, or other suitable things. Moreover, a pocket 125 and a jack for power wire 123 are provided on one lateral side of the arm 12. The pocket 125 is used for users to place their things therein and the jack for power wire 123 is used for connecting a power wire 5. When in places with external power supply, users can utilize external power supply as power source by inserting one end of the power wire 5 into the jack for power wire 123 and the other end into an external socket. Besides, an audio connecting line 122 is provided within the pocket 125 for receiving audio signals from outside and the audio signals can be output via the speakers 104.

Besides, in this embodiment, the other arm 12 is provided with a recessed space 126 and the table 2 is pivotally connected to the recessed space 126 of the arm 12 via a connecting arm 20. As shown in FIG. 2, the table 2 can be folded into the recessed space 126 by moving the connecting arm 20. The table 2 can be used for users to put books, a notebook computer, personal carry-on things, or other suitable things.

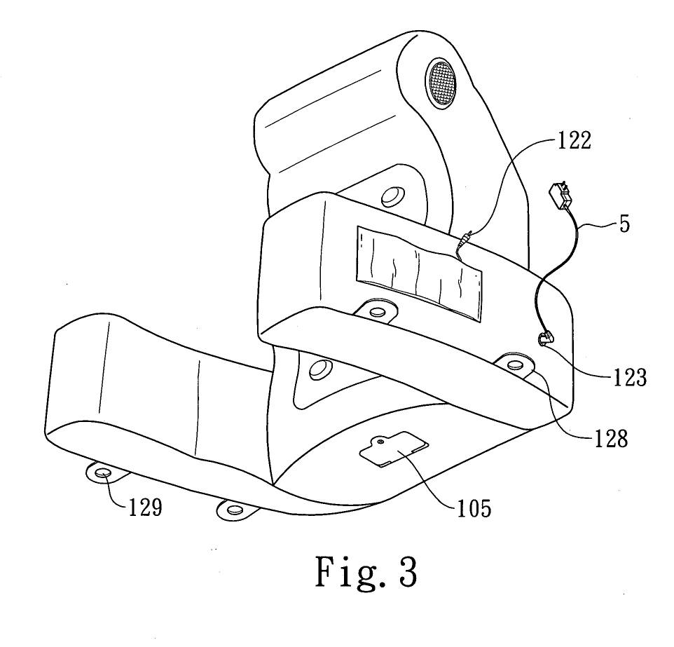

FIG. 3 shows another perspective view of the first embodiment according to the present invention. As shown in FIG. 3, the battery cell 105 is provided on the bottom of the cushion 10 for use in places without power supply. For example, if users go on a picnic or go camping outdoors, they can use the foldable massaging backrest structure according to the present invention by putting batteries into the battery cell 105 as power source. If users are in places with sufficient power supply, they can operate the foldable massaging backrest structure according to the present invention by inserting the power wire 5 connected with an external socket into the jack for power wire 123. By this way, power can be supplied to operate the foldable massaging backrest structure or to re-charge the batteries in the battery cell 105 as reserve power.

Furthermore, at least one nail seat 128 having at least a hole 129 is extending from one side of each arm 12 near its bottom for fixing the foldable massaging backrest structure. As shown in FIG. 3, two nail seats 128 are extended from the two ends of one side of each arm 12 near its bottom. The nail seat 128 can be made by fabric or plastic material. When the foldable massaging backrest structure of the present invention is used in situations such as outdoor activities or camping, it will be inclined backward easily by the back of a user when the user leans against the cushion 10 because of its light weight. This problem can be solved by inserting a nail (not shown in this figure) through the hole 129 of the nail seat 128 into grasslands, so that the foldable massaging backrest structure can be firmly fixed to the grasslands.

In this embodiment, the cushion 10 and the two arms 12 are filled with foam material therein for reducing the weight of the foldable massaging backrest structure of the present invention, so that it is portable for users to carry.

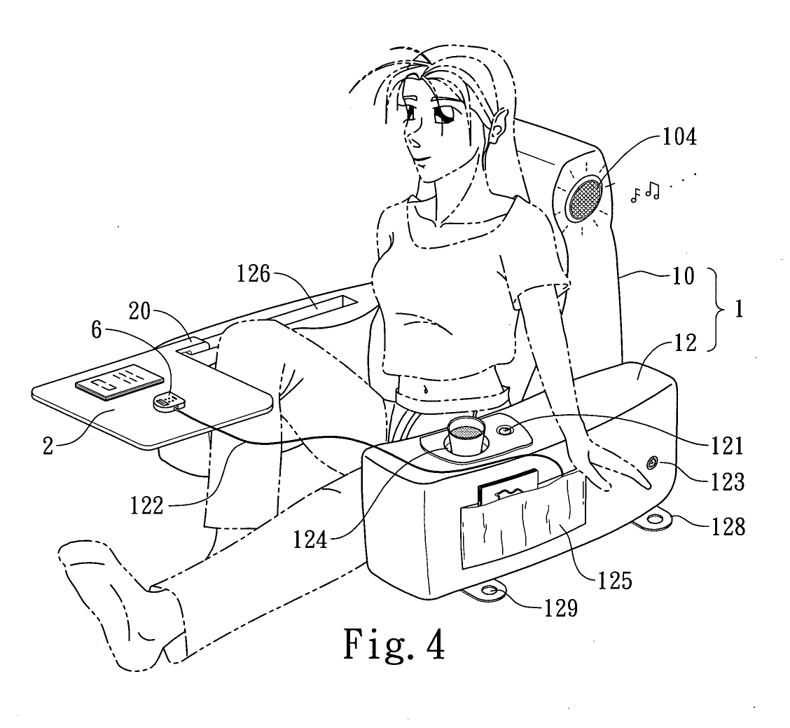

FIG. 4 shows a using state diagram of the first embodiment according to the present invention. As shown in FIG. 4, a user can put a cup in the recessed seat 124, turn on or off the massaging device 103 (not shown in this figure) by using the power switch 121, and make the speaker 104 send off sounds by connecting the audio connecting line 122 with a player 6, such as a MP3, for the user to listen to preferred music or speech recordings or broadcasts while enjoy a massage. Besides, the user can put things like a notebook computer, a player, a book, a watch, a wallet, or other things on the table 2 after moving the table 2 from the recessed space 126 of the arm 12 to the front of the user.

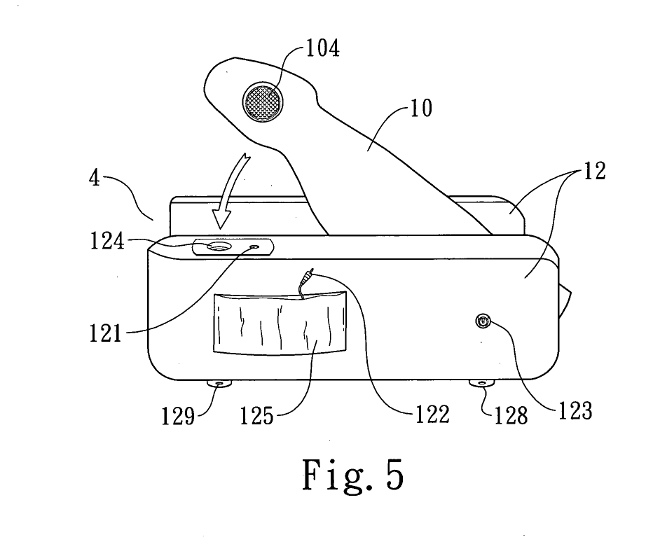

When the foldable massaging backrest structure is to be stored, as shown in FIG. 5, a user can store it by moving the table 2 back into the recessed space 126 of the arm 12 first and then folding the cushion 10 into the space 4 formed between the cushion 10 and two arms 12 along the arrow direction.

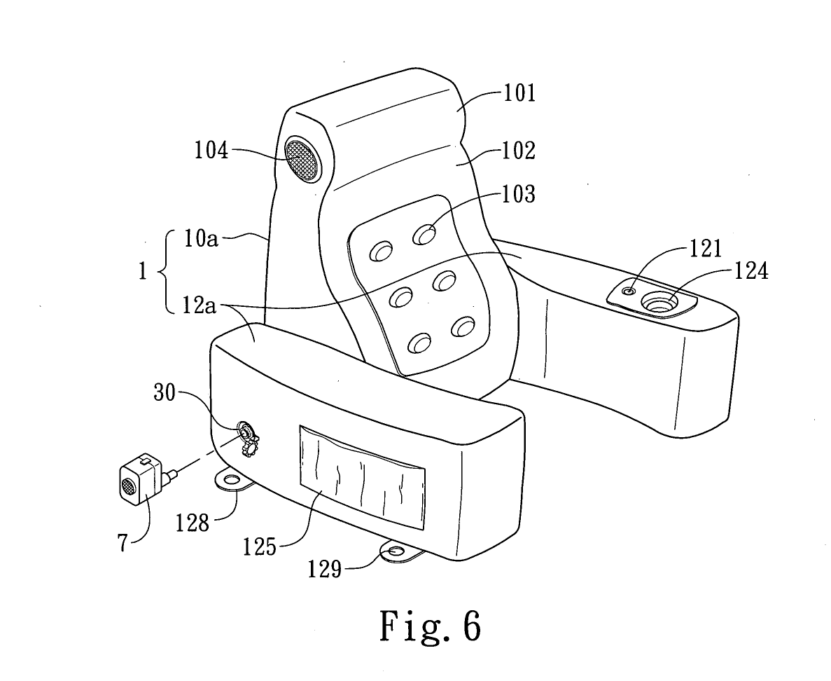

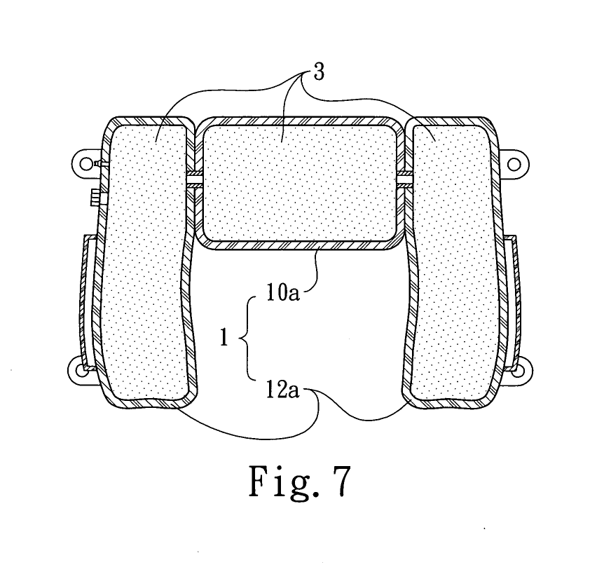

FIGS. 6 and 7 show a perspective view and a sectional view of a second embodiment according to the present invention. For the purpose of describing this embodiment conveniently, the same structure will be assigned with the same number used in the first embodiment. Compared with the first embodiment, a cushion 10a and two arms 12a of the foldable massaging backrest structure are provided with an air bag 3 therein respectively. Besides, the main body 1 is provided with at least a valve 30 communicative to the air bags for inflation or deflation of the cushion 10a and the arms 12a. As shown in FIG. 6, one arm 12 is provided with a valve 30 on one lateral side. Users can inflate or deflate the cushion 10a and the arms 12 by using an air pump 7.

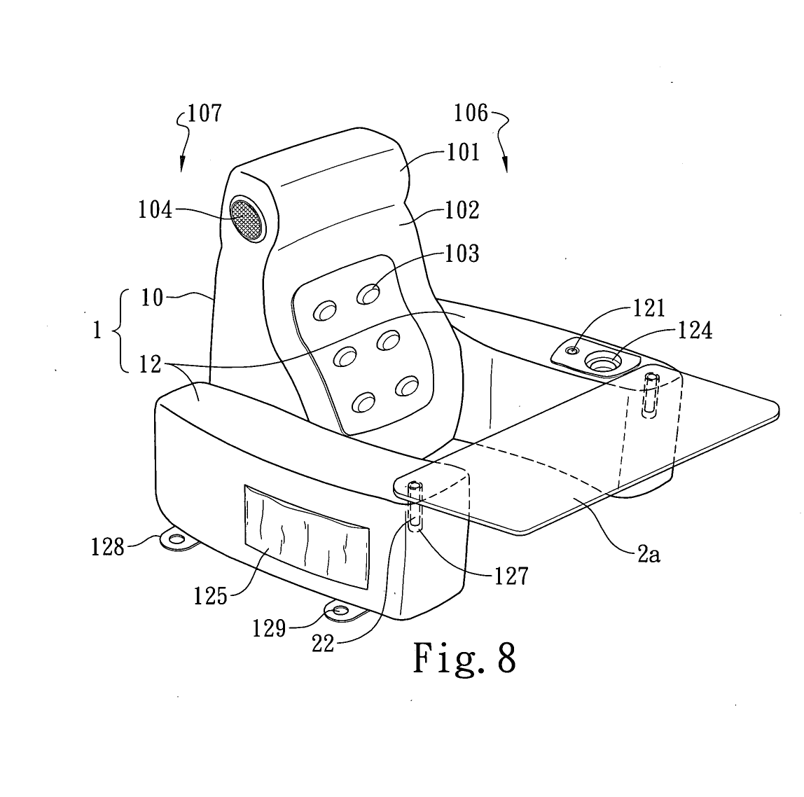

FIG. 8 shows a perspective view of a third embodiment according to the present invention. For the purpose of describing this embodiment conveniently, the same structure will be assigned with the same number used in the first embodiment. In the third embodiment, two ends on the bottom side of a table 2a are provided with a connecting part 22 respectively that extends vertically and downwardly from the bottom of the table 2a and two ends on the topside of each arm 12 are respectively provided with a recess 127 corresponding to the connecting part 22 of the table 2a. When in practice, users can put their things on the table 2a after connecting the table 2a to the arms 12 by inserting the connecting part 22 into its corresponding recess 127.

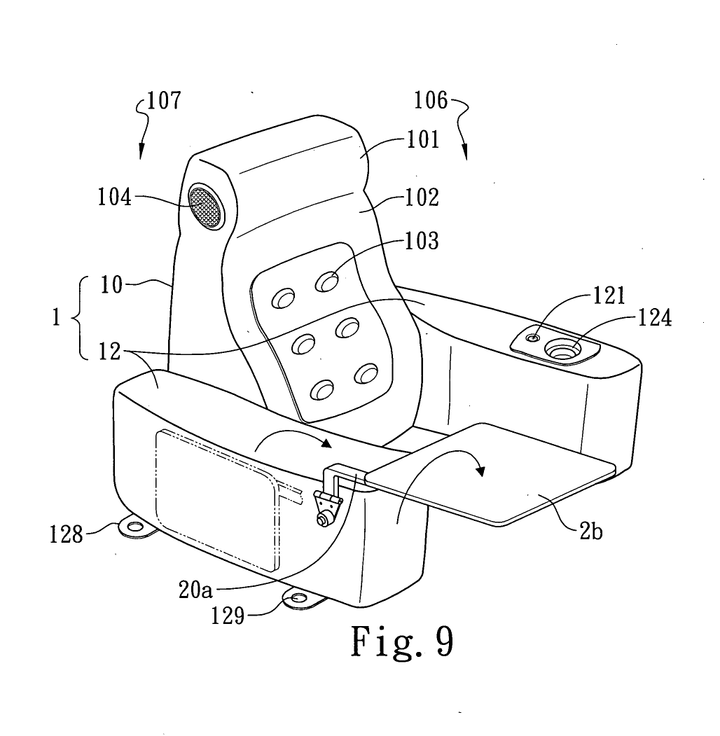

FIG. 9 shows a perspective view of a fourth embodiment according to the present invention. For the purpose of describing this embodiment conveniently, the same structure will be assigned with the same number used in the first embodiment. In the fourth embodiment, a table 2b is pivotally connected to one lateral side of one arm 12 via a connecting arm 20a. When in practice, users can put things on this table 2b by moving it from the lateral side of the arm 12 toward the front of the users.

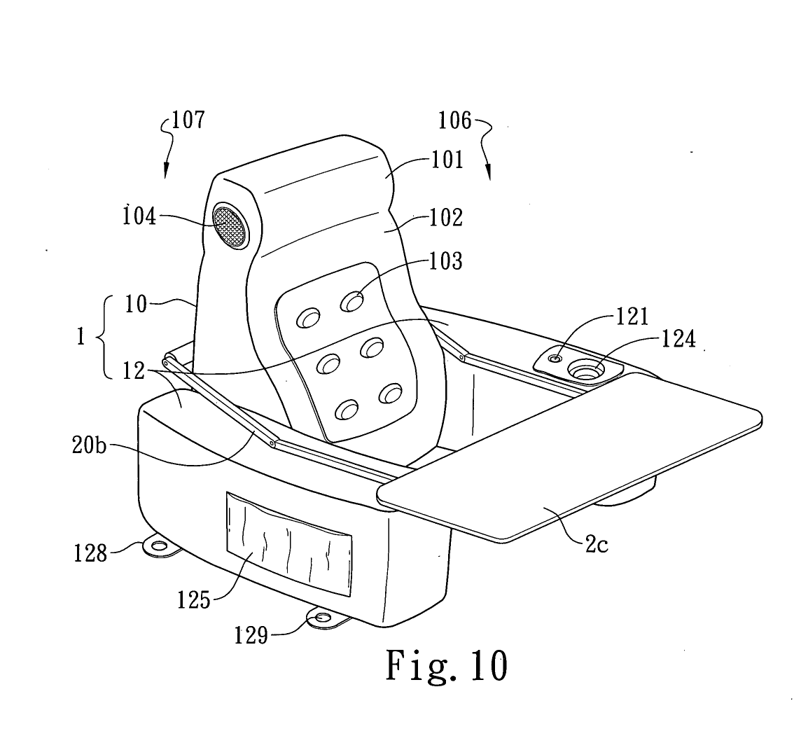

FIG. 10 shows a perspective view of a fifth embodiment according to the present invention. For the purpose of describing this embodiment conveniently, the same structure will be assigned with the same number used in the first embodiment. In the fifth embodiment, two ends of the bottom side of a table 2c are respectively connected with a connecting arm 20b and the cushion 10 is provided with a connecting portion 130 on the surface of an external side 107 of the cushion 10. The two connecting arms 20b are pivotally connected to two ends of the connecting portion 130 respectively. When in practice, users can put things on this table 2c by moving it from the external side 107 of the cushion 10 toward the front of the users.

Thereby, the present invention has following advantages:
1. The foldable massaging backrest structure according to the present invention has advantageous features including low manufacturing cost, simple structure, small size, and portableness.
2. By disposing the foldable massaging backrest structure according to the present invention with a table, users can put their carry-on things or books they are reading on the table.
3. The foldable massaging backrest structure according to the present invention is disposed with a massaging device for massaging the backs of users.
4. The cushion and the arms of the foldable massaging backrest structure according to the present invention are filled with foam material or disposed with air bags therein so that the weight of the whole structure is reduced and make it convenient for users to carry them outside.
5. By disposing the foldable massaging backrest structure according to the present invention with a battery cell, users can utilize batteries as power source when in places without power supply, such as a camping site.
6. By disposing the foldable massaging backrest structure according to the present invention with a jack for connecting with a power wire, users can utilize the present invention by connecting the structure with a electric socket via a power wire when in places with power supply.
7. By disposing the foldable massaging backrest structure according to the present invention with an audio jack and a speaker, users can have massages and listen to recordings of music or speech or broadcasts at the same time.
8. By disposing the foldable massaging backrest structure according to the present invention with a recessed seat on the arm and a pocket, users can put their carry-on things.
9. By disposing the foldable massaging backrest structure according to the present invention with nail seats, the structure can be fixed firmly on the ground.

Accordingly, as disclosed in the above description and attached drawings, the present invention can provide a foldable massaging backrest structure that is lightweight, small, portable, and of low manufacturing cost. It is new and can be put into industrial use.

It should be understood that different modifications and variations could be made from the disclosures of the present invention by the people familiar in the art, which should be deemed without departing the spirit of the present invention.

What is claimed is:

1. A foldable massaging backrest structure, comprising:
a main body including a cushion and two arms pivotally connected with two lateral sides of the cushion, wherein the cushion has a headrest portion and a backrest portion and is provided with at least a speaker and a battery cell, and a massaging device is disposed within the backrest portion adjacent to the back of a user; and
a table movably connected to the main body for uses to place things thereon.

2. The foldable massaging backrest structure as claimed in claim 1, wherein the table further has a connecting part on each end of its bottom side and on the topside of each arm is provided with a recess for receiving the connecting part of the table, and the table is movably connected to the two arms by inserting the connecting part into its corresponding recess.

3. The foldable massaging backrest structure as claimed in claim 1, wherein the table is further provided with a connecting arm pivotally connected to one arm, and the table is able to be moved from a lateral side of the arm to the front of users.

4. The foldable massaging backrest structure as claimed in claim 3, wherein the arm pivotally connected with the connecting arm is further provided with a recessed space for placing the table therein.

5. The foldable massaging backrest structure as claimed in claim 1, wherein the table is further provided with two connecting arms pivotally and respectively connected to two arms, so that the table is able to be moved from a external side of the cushion to the front of users.

6. The foldable massaging backrest structure as claimed in claim 1, wherein the cushion and the arms are disposed with at least an air bag respectively and the air bags within the cushion and the arms are communicative to each other, and the main body is further provided with at least a valve communicative to the air bags for inflation or deflation of the cushion and the arms.

7. The foldable massaging backrest structure as claimed in claim 1, wherein the cushion and the arms are filled with foam material.

8. The foldable massaging backrest structure as claimed in claim 1, wherein one of the arms is provided with a power switch for controlling the massaging device and an audio connecting line in electronic connection with the speaker for receiving external audio signals.

9. The foldable massaging backrest structure as claimed in claim 1, wherein the main body is further provided with a jack for power wire to utilize external power supply.

10. The foldable massaging backrest structure as claimed in claim 1, wherein at least one arm is further provided with a recessed seat for users to place things thereon.

11. The foldable massaging backrest structure as claimed in claim 1, wherein at least a nail seat is extended from the bottom of each arm and the nail seat has a hole centrally for fixing the foldable massaging backrest structure.

12. The foldable massaging backrest structure as claimed in claim 1, wherein at least one arm is further provided with a pocket connected to one lateral side of the arm for users to place things therein.
